(19) United States
(12) Patent Application Publication
(10) Pub. No.: US 2013/0068188 A1
(43) Pub. Date: Mar. 21, 2013

(54) ARRANGEMENT IN A COMBUSTION ENGINE

(71) Applicants: Fredrik Liander, Huddinge (SE); Per Larsén, Sodertalje (SE)

(72) Inventors: Fredrik Liander, Huddinge (SE); Per Larsén, Sodertalje (SE)

(21) Appl. No.: 13/699,071

(22) PCT Filed: Jun. 14, 2011
(86) PCT No.: PCT/SE2011/050726

§ 371 Date: Nov. 20, 2012

(30) Foreign Application Priority Data
Jun. 16, 2010 (SE) 1050613-7

(51) Int. Cl. F02F 1/24

(52) U.S. Cl. 123/193.3

(57) ABSTRACT

In a combustion engine including a cylinder (11), a cylinder head (12), a cylinder head seal (16) and a scraper ring (17), an elastic scraper ring seal (23, 30) provided close to either or both end surfaces (20, 21) of the scraper ring separates volumes formed close to the scraper ring from the combustion chamber. Separating these volumes from the combustion space prevents the accumulation of residues of incompletely burnt fuel in these volumes to improve the engine's efficiency, reduce emission values and lengthen the engine service life.

### TECHNICAL FIELD

The invention relates to an arrangement in a combustion engine according to the preamble of claim 1.

### BACKGROUND

Combustion engines of the piston engine type have one or more pistons, each of which, when the engine is in operation, move to and fro in a cylinder situated in a cylinder block. The upper ends of the cylinders are closed by a cylinder head which is so configured that a combustion chamber is formed in the space situated in each cylinder between the cylinder head and the upper side of the piston. Air is supplied to the combustion chamber and is compressed when the piston moves towards the cylinder head. At suitable times, fuel is added to the air, and when the piston is close to its uppermost position in the cylinder the fuel ignites, burns and expands, with the result that the piston is pushed downwards in the cylinder. The motion of the piston is transmitted and is thereafter converted to a rotary motion of a crankshaft. For effective combustion it is important for there to be good sealing between the outer periphery of the piston and the inside of the cylinder. For manufacturing technology reasons, however, there has to be a certain clearance between the periphery of the piston and the inside of the cylinder. This clearance is sealed by means of piston rings placed in grooves in the outer periphery of the piston, and by lubricating oil. For various reasons, e.g. the high temperature reached close to the combustion chamber, the grooves are situated slightly below the upper corner of the piston. This means that after a period of use the periphery round the upper end of the piston is coated with so-called coke in the form of incompletely burnt residual products from the combustion of the fuel in the combustion chamber. This coating has adverse effects on the engine's efficiency and emission values.

A solution to limit the coke coating on the piston is to provide inside the upper end of the cylinder a so-called scraper ring which has an inside radius somewhat smaller than the cylinder, with the result that it scrapes against the outer periphery of the piston and removes the coating which forms on the piston. Such a solution is referred to in, for example U.S. Pat. No. 6,164,260. Such a scraper ring is sometimes called saver ring.

For good efficiency in the combustion process and low emission values in the exhaust gases, the configuration of the combustion chamber is important. To achieve desired results, the configuration needs to cater for several different parameters. An important parameter is that the combustion chamber should be so configured that as large a proportion as possible of the fuel supplied is burnt in the chamber. To achieve this, it is important that volumes associated with, but situated some distance away from, the centre of the chamber are minimised, since fuel/air mixture in these volumes tends not to burn in an optimum way. In combustion engines provided with scraper rings, these volumes unfortunately increase, with consequent adverse effects on efficiency, emissions and engine service life. There is therefore need for an arrangement which does not have these disadvantages.

### SUMMARY OF THE INVENTION

The object of the present invention is to meet the above need. This is achieved by an arrangement according to claim 1.

The arrangement according to the invention meets the need described above in that the scraper ring seal separates spaces between the end of the scraper ring and the recess in the cylinder or the cylinder head. The volume increase is thus reduced in that the recess for the scraper ring is separated from the volume in the combustion chamber.

The scraper ring seal is so configured that when the cylinder head is fitted to close the cylinder, the scraper ring seal is compressed and thereby reliably seals portions of the space which accommodates the scraper ring. Scraper ring seals may be situated close to either or both of the axial ends of the scraper ring, depending on the configuration of the scraper ring, the cylinder and the cylinder head.

Scraper ring seals may be situated close to one or both of the ends of the scraper ring. The effect of the invention depends on how large a proportion of the undesirable volumes can be separated off.

In an embodiment of the arrangement, the scraper ring has a substantially constant inside radius and its first and second ends are each substantially perpendicular relative to the longitudinal axis. The scraper ring further has an outer surface which matches the shape of the recess in the cylinder. This embodiment is advantageous in that the scraper ring seal situated between the end of the scraper ring and the edge of the recess can be compressed round the whole cylinder, and the volume formed in the recess close to the scraper ring is separated from the space which constitutes the cylinder's combustion chamber.

In an embodiment of the arrangement, the scraper ring seal is situated close to the second end of the scraper ring, which faces away from the cylinder head in the form of an elastic sealing ring situated between the end of the scraper ring and the edge of the recess which is adjacent to the end of the scraper ring. This embodiment results in a relatively simple arrangement which provides a good seal round the whole circumference of the scraper ring so that disadvantages which occur in engines provided with scraper rings are thereby reduced.

In various embodiments of the arrangement, the scraper ring seal or seals take the form of elastic fibre material, elastic metal material, a metal washer with a shape which renders it elastic, or a chemical substance which hardens to form an elastic seal. These various materials result in scraper ring seals which achieve good sealing of the volume situated close to the recess for the scraper ring, and can tolerate the high temperatures and pressures which occur in connection with and because of the combustion in the cylinder chamber.

In an embodiment of the arrangement, the scraper ring seal is situated close to the first end of the scraper ring, which faces towards the cylinder head in the form of an integral part of the cylinder head seal. This embodiment affords the advantage of involving no further parts, making the arrangement easier to manufacture and fit. The cylinder head seal is so configured that it protrudes radially inwards above the end of the scraper ring which faces towards the cylinder head seal. However, after the seal has been compressed during fitting, it should not extend into the inner hollow of the scraper ring.

In an embodiment of the arrangement, the scraper ring seal and the cylinder head seal are made of metal material whose edge close to the second end of the scraper ring takes the form of an edge which is angled towards the second end of the scraper ring, rendering it elastic. The angled edge abuts against the end of the scraper ring and has elastic characteristics by its very shape, without the material inherently being particularly elastic. This embodiment is very advantageous in that the cylinder head seal may be made of a material which achieves the desired seal and is tolerant of the high temperatures and pressures to which it is exposed, without also needing to be elastic in order to serve also as scraper ring seal.

The invention relates also to a combustion engine provided with at least one arrangement according to any of the embodiments described above.

The various embodiments may of course be combined in various ways.

### BRIEF DESCRIPTION OF THE DRAWINGS

The invention is described in more detail below with reference to the drawings, in which

FIGS. 1 and 2 depict a first embodiment of the invention,

FIG. 3 depicts a second embodiment of the invention,

FIGS. 4 and 5 depict respective cross-sections of the embodiment according to FIGS. 1 and 2 and the embodiment according to FIG. 3 of the scraper ring seals in an unfitted state.

### DETAILED DESCRIPTION OF THE INVENTION

The drawings depict selected parts of a combustion engine in cutaway form. The arrangement is intended to be used in a combustion engine, e.g. a diesel engine, which has one or more undepicted pistons each arranged to be movable in a cylinder with a longitudinal axis A which is accommodated in an undepicted engine block. The cylinders take with advantage the form of cylinder liners fitted in purpose-made spaces in the engine block. Alternatively, the cylinders may be formed directly in the engine block. Cylinder in the ensuing description means the space in which a piston is arranged to be movable, irrespective of whether the cylinder is an integral part of the engine block or is a cylinder liner intended for fitting in the engine block.

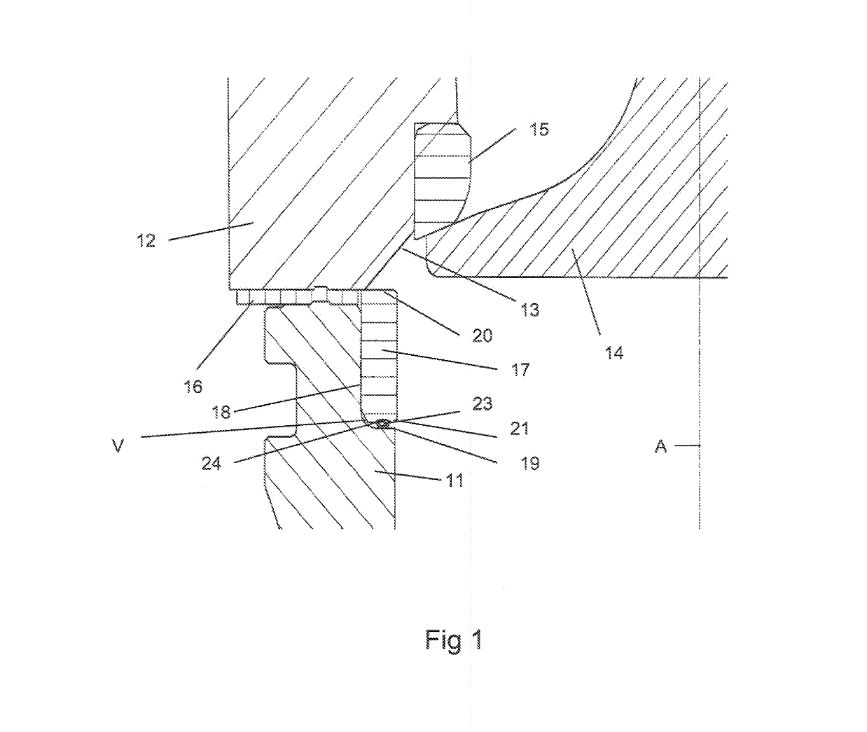

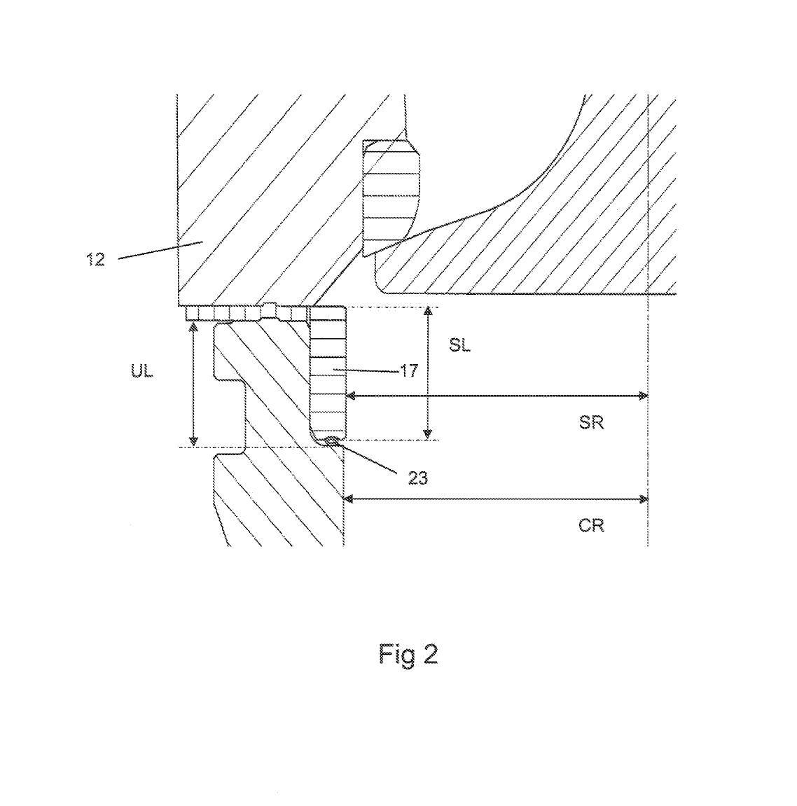

FIG. 1 and FIG. 2 depict a first embodiment of the arrangement according to the invention. A cylinder 11 extends from an undepicted crankcase and is closed at an opposite end by a cylinder head 12. The cylinder head 12 accommodates a recess 13 which in conjunction with the side of the piston which faces towards the cylinder head 12 forms a combustion chamber in which air and fuel are compressed and are burnt so that the piston, owing to the expansion which occurs during the explosive combustion, moves away from the cylinder head 12 towards the crankcase, in which the motion of the piston is converted to rotary motion of a crankshaft.

The cylinder head accommodates close to the recess 13 one or more valves 14 which cooperate with valve seats 15 to control air supply to the combustion chamber, and to evacuate combustion gases from the combustion chamber. If the engine has two or more cylinders, each of them is with advantage closed by a cylinder head.

To ensure that the closure of the cylinder is tight, a cylinder head seal 16 is placed between the cylinder 11 and the cylinder head 12. The cylinder head 12 is usually fastened to the engine block by some kind of threaded connection.

A so-called scraper ring 17 is provided at the end of the cylinder 11 which faces towards the cylinder head 12. The scraper ring 17 has a constant inside radius SR somewhat smaller than the inside radius CR of the cylinder 11. This means that the scraper ring 17 will scrape against the piston's undepicted outer periphery when it passes the scraper ring 17, whereupon any coating on the piston will be scraped off. This reduces the coating which accumulates on the piston over time.

The scraper ring 17 is accommodated in a purpose-made annular recess 18 in the cylinder 11 and extends round the inner periphery of the cylinder close to the cylinder's end which faces towards the cylinder head. Both the outside of the scraper ring and the configuration of the recess may vary so long as the scraper ring is accommodated, and can be fitted, in the recess 18. However, for it to be possible to fit the scraper ring in the recess 18 there has to be a certain clearance between the scraper ring's outer periphery and the recess 18. This clearance results in spaces which, if they communicate with the combustion chamber, have adverse effects on the combustion in the combustion chamber.

The arrangement aims to separate these spaces from the combustion chamber by means of elastic seals situated adjacent to the scraper ring.

In the embodiment depicted in FIG. 1 and FIG. 2, the respective upper and lower end surfaces 20 and 21 of the scraper ring are substantially perpendicular relative to the centreline A. The edge surface 19 of the recess which abuts against the lower end surface 21 of the scraper ring is likewise substantially perpendicular relative to the centreline A. An elastic sealing ring 23 is placed between the end surface 21 of the scraper ring and the edge surface 19 of the recess. The combined axial length (SL+TL) of the scraper ring (SL) and the sealing ring (TL) before fitting is greater than the combined axial length (UL+CL) of the recess (UL) and the cylinder head seal (CL), so that the scraper ring 17 which abuts against the cylinder head 12 after fitting compresses the sealing ring 23 to effect good sealing between the end surface 21 of the scraper ring and the edge surface 19 of the recess. A volume V behind the scraper ring is thus separated from the combustion chamber. To facilitate fitting and reduce the risk that the elastic sealing ring might reach an incorrect position relative to the cylinder and the scraper ring, a small depression 24 is formed in the end surface of the scraper ring to keep the sealing ring in desired position. The edge surface of the recess may also be provided with grooves, although this is not depicted in FIG. 1.

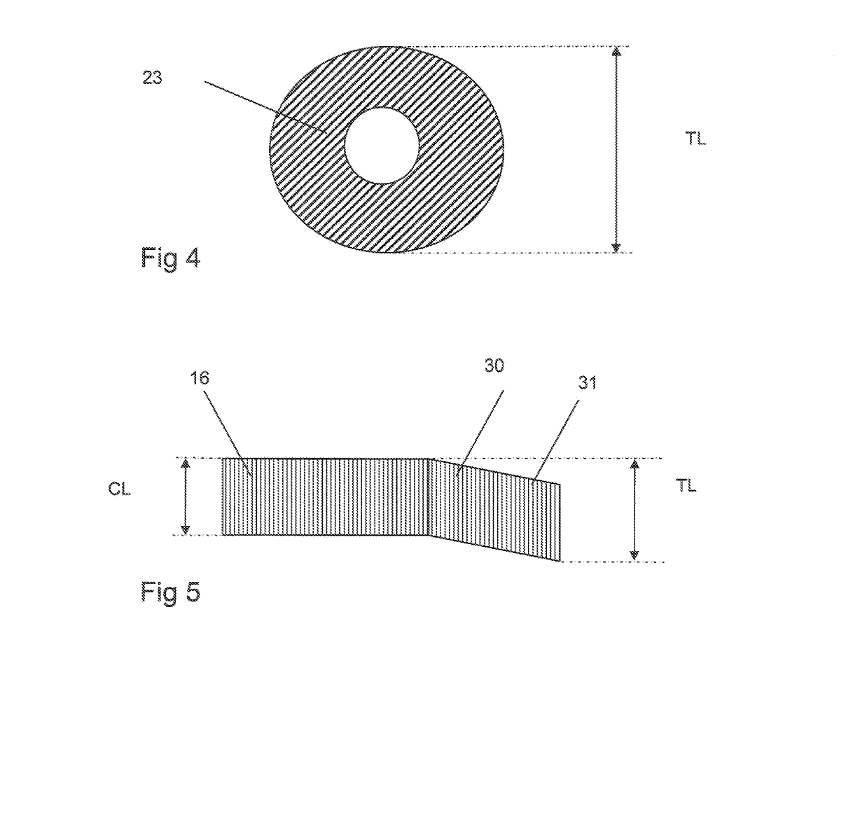

The sealing ring 23 may have different cross-sectional shapes to suit the respective configurations of the recess and the scraper ring. The sealing ring has either a homogeneous cross-section or a cavity accommodated in the sealing ring. The configuration of the sealing ring 23 depicted in cross-section in FIG. 4 is provided with such a cavity. These parameters may be used to achieve a scraper ring seal of desired elasticity, since different materials require different configurations of the sealing ring. In alternative embodiments, this elasticity may be achieved by the scraper ring seal taking the form of elastic fibre material, elastic metal material, a metal washer with a shape which renders it elastic, or a chemical substance which hardens to form an elastic seal.

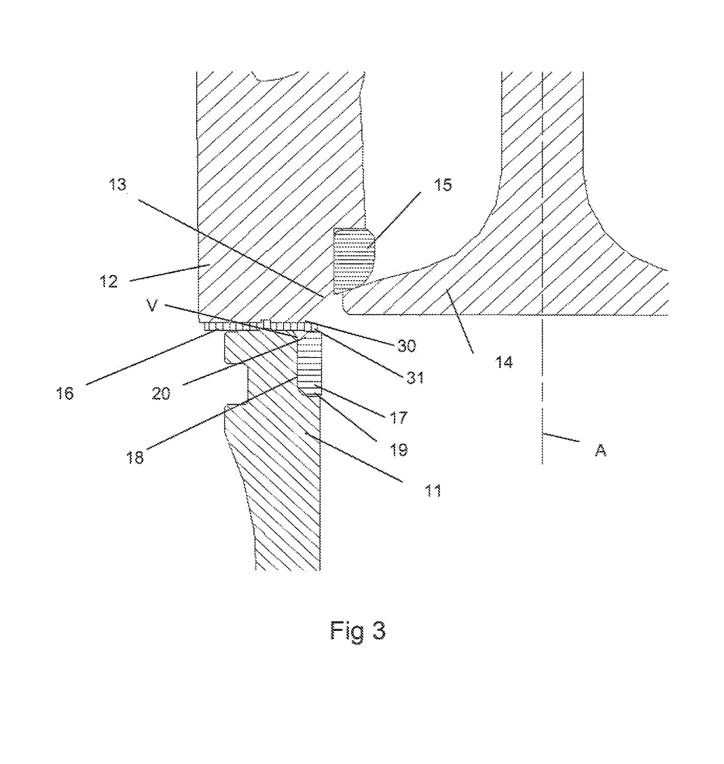

Another embodiment of the arrangement is depicted in FIG. 3. In this version the scraper ring seal 30 is integrated with the cylinder head seal 16 close to the upper end 20 of the scraper ring 17. The scraper ring seal 30 takes the form of an angled edge 31 which protrudes from the cylinder head seal 16 and which extends down towards the upper end 20 of the scraper ring so that the resulting volume V between the scraper ring, the cylinder and the angled edge is separated from the combustion chamber. A cross-section of this embodiment of the sealing ring 30 is depicted in FIG. 5 in an unfitted state.

Cylinder head seals do not usually have the elasticity required of the scraper ring seal, but the angled edge 31 provides the desired elasticity in the scraper ring seal 30.

The combined axial length (SL+TL) of the scraper ring (SL) and the angled edge (TL) before fitting of the arrangement is greater than the combined axial length (UL+CL) of the recess (UL) and the cylinder head seal (CL) so that the cylinder head and the scraper ring after fitting compress the angled edge 31 to effect good sealing between the upper end of the scraper ring, the angled edge and the volume V close to the upper end of the scraper ring, thus separating the recess from the adjacent combustion chamber.

The embodiment depicted in FIGS. 1 and 2 and the embodiment depicted in FIG. 3 may with advantage be combined in the combustion engine to achieve maximum effect.

The invention is described above on the basis of two exemplifying embodiments. However, it is not confined to them, but is defined on the basis of the accompanying claims. The arrangement may be configured in different ways so long as the internal relationships between the constituent parts correspond mutually.

1. A combustion engine comprising:
at least one cylinder with a longitudinal axis in an axial direction, a cylinder head closing the cylinder at one end;
a cylinder head seal situated between the cylinder and the cylinder head;
a recess around an inner periphery of the cylinder adjacent to the cylinder head seal;
a scraper ring having a first axial end surface and an opposite second axial end surface, the scraper ring being in the recess, the scraper ring having an axial length that is shorter than a combined axial length of the recess and the at least one cylinder head seal;
at a location close to either or both of the axial end surfaces of the scraper ring, an elastic scraper ring seal having an axial length in an unfitted state of the scraper ring seal such that the axial length of the scraper ring seal plus the axial length of the scraper ring exceeds the combined axial length of the recess and the at least one cylinder head seal.

2. An arrangement according to claim 1, wherein the scraper ring has a substantially constant inside radius, and the respective first and second axial end surfaces are each substantially perpendicular relative to the longitudinal axis and relative to an outer surface of the scraper ring, and the recess having a shape that corresponds to a shape of an outer surface of the scraper ring.

3. An arrangement according to claim 1, wherein the scraper ring seal is situated close to the first axial end surface of the scraper ring and the first axial end surface faces away from the cylinder head; and
the scraper ring seal comprises an elastic sealing ring placed between an edge surface of the recess and the second end surface of the scraper ring.

4. An arrangement according to claim 1, wherein the scraper ring seal is comprised of elastic fiber material, elastic metal material, a metal washer with a shape which renders it elastic, or a chemical substance which hardens to form an elastic seal.

5. An arrangement according to claim 1, wherein the scraper ring seal is situated close to the second axial end surface of the scraper ring which faces towards the cylinder head, and the scraper ring seal comprises an integral part of the cylinder head seal.

6. An arrangement according to claim 5, wherein the scraper ring seal and the cylinder head seal are comprised of metal material, and the cylinder head seal having an edge close to the second end of the scraper ring, and the edge is angled towards the first end surface of the scraper ring sufficient to cause the scraper ring seal at the edge of the recess to be rendered elastic.

7. A combustion engine comprising at least one arrangement according to claim 1.
